(19) United States
(12) Patent Application Publication
(10) Pub. No.: US 2007/0056451 A1
(43) Pub. Date: Mar. 15, 2007

(54) Composite printing die

(76) Inventor: Kenneth J. Klann, Vadnais Heights, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/227,458

(22) Filed: Sep. 15, 2005

(51) Int. Cl. B44C 1/24

(52) U.S. Cl. 101/32

(57) ABSTRACT

A composite printing die having a body and a texture selectively defined thereon to form a printing surface, the body including a polymeric matrix and a filler dispersed in the polymeric matrix, wherein the filler includes particles made of an elemental metal, any alloys thereof, and any combinations thereof.

### FIELD OF THE INVENTION

This invention relates generally to printing dies. More particularly, this invention relates to a composite die for use in various printing processes.

### BACKGROUND OF THE INVENTION

Those involved in printing operations have used hot foil printing processes to stamp or emboss metallic, clear, or colored foils onto various substrates, such as pocket calendars, passports, books, and greeting cards.

Before the foil printing process can begin, the desired wording or design texture must be created on the face of a printing plate or die. Magnesium, copper, and various brasses are often used as a die material because of their high thermal conductivity. The designs are often etched onto the face of the die using a photo mask and acid, such as hydrochloric acid.

When using the acid etch process, the wording and/or designs can generally only be done in a single depth, as the depth is controlled only by the type and concentration of acid used and the etch duration. In addition, because the acid must chemically etch away the die material, processing times generally can exceed eight hours.

Once the design has been etched into the die, the die can be mounted onto a heated block, which is generally heated to an elevated temperature. As foil is transferred on a roll from a first full spindle to a second spent roll through a position intermediate the heated die and the substrate, the heated die can be pressed against the plastic foil substrate carrying the foil so that the foil comes into contact with the media with a specific pressure for a specific period of time. The combination of pressure, temperature, and duration enables the foil to be transferred from the foil roll to the substrate.

There are numerous inherent deficiencies with conventional dies. For example, the long processing times needed to create a design on a metal die can lead to significant turnaround times. Because the etching processing times can exceed eight hours, turnaround for any foil printing using such dies generally exceeds eight hours. If more than one design depth is desired, for instance, to add texture to the design, further etching must be performed, thus leading to additional processing times.

In addition, because there are inherent resolution limitations to using chemical etching to obtain a design on a die, the resolution of the acid-etched magnesium die can be generally low. Moreover, once the acid etching process is completed, the acid and treatment water must be disposed of, thus potentially causing an environmental concern.

When placing the magnesium die on the heated block, an adhesive layer is usually used on the back of the die. The die is generally manually positioned. This can lead to poor placement of the die. If a user desires to assure that the die is in correct positioning on the heated block, positioning or registering holes can be drilled or machined into the die. However, this requires an addition step beyond the acid etching process and can lead to additional time for turnaround of the die and/or substrate produced using the die.

Because the deficiencies discussed above have not been addressed by conventional hot foil printing dies, there is a current need for a die for use in a foil printing process addressing the problems and deficiencies inherent with conventional designs.

### SUMMARY OF THE INVENTION

The composite die of the various embodiments of the present invention substantially solve the problems of conventional printing dies by providing a composite die that is laser etchable, has a high thermal conductivity, and that can be used to produce images with high resolution in various thermal transfer media, such as foil and colored pigment.

A feature and advantage of the various embodiments of the present invention is that a design can be formed in the die using a one-step process, which can minimize processing and turnaround times.

Another feature and advantage of the various embodiments of the present invention is that the laser etching process can create a multi-depth design in a single process. The design can have high resolution and can include gradients or curved surfaces between different levels of the design.

A further feature and advantage of the various embodiments of the present invention is that no acid is needed to etch the die, leading to less wasted material and no need to dispose of acid-laden cleaning water. The die burns clean under the laser and oxidizes completely. The die material is also significantly recyclable, as up to and over fifty-percent of the die material is virgin material.

Another feature and advantage of the various embodiments of the present invention is that the die is magnetic, leading to better coupling between the die and the heated block, which thus enables precise placement of a design on the desired media. In addition, positioning holes can be laser etched into the die during the laser etching process, which can further enable precise placement of a design on the desired media.

Another feature and advantage of the various embodiments of the present invention is that the die can also be used for other printing processes such as embossing plastics or paper and thermal transfer printing using colored pigment “foil,” which can be hot glue or polymer that is pigmented and disposed on a backing or substrate.

### BRIEF DESCRIPTION OF THE DRAWINGS

FIG. 1 is a perspective view of a composite printing die according to the present invention;

FIG. 2 is a cross-sectional view of a composite printing die according to a first embodiment depicting the structure of the die;

FIG. 3 is a cross-sectional view of a composite printing die according to a second embodiment depicting the structure of the die wherein approximate boundaries of layers of the die are depicted in phantom lines;

FIG. 4 is a cross-sectional view of a composite printing die according to a third embodiment depicting the structure of the die wherein approximate boundaries of layers of the die are depicted in phantom lines;

FIG. 5 is a cross-sectional view of a composite printing die according to a fourth embodiment depicting the structure of the die wherein approximate boundaries of layers of the die are depicted in phantom lines;

FIG. 6 is cross-sectional view of a composite printing die depicting a design having a single depth;

FIG. 7 is cross-sectional view of a composite printing die depicting a design having multiple depths;

FIG. 8 is cross-sectional view of a composite printing die depicting a design having a single depth with a curved gradient;

FIG. 9 is cross-sectional view of a composite printing die depicting a design having a multiple depth with linear and curved gradients;

FIG. 10a is a schematic of a hot foil printing process depicting a substrate prior to being printed upon;

FIG. 10b is a schematic of a hot foil printing process depicting a substrate during printing; and

FIG. 10c is a schematic of a hot foil printing process depicting a substrate after being printed upon.

### DETAILED DESCRIPTION OF THE PREFERRED EMBODIMENTS

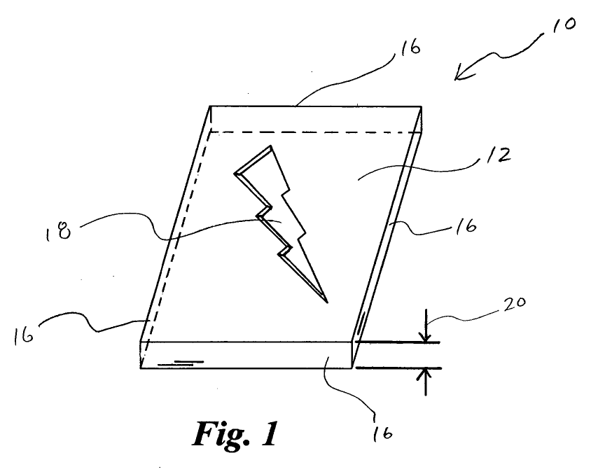

FIGS. 1-7 depict a composite printing die 10 according to the present invention. The composite die 10 can be used in a hot foil process to transfer, stamp, or emboss colored, clear, and holographic foils onto various media, such as pocket calendars, passports, books, and greeting cards. The die can also be used for other printing processes such as embossing plastics or paper and thermal transfer printing using colored pigment “foil,” which can be hot glue or polymer that is pigmented and disposed on a backing or substrate.

Referring to FIG. 1, the composite die 10 broadly includes a first surface 12, a generally opposed second surface 14, and a plurality of edges 16, the number of edges 16 depending upon the general shape of the die 10. For example, square or rectangular dies 10 can comprise four edges 16 and other polygonal dies can comprise three or more edges 16. Dies 10 having circular, oval, or generally arcuate shapes can comprise one, generally continuous edge 16. In addition, the dies 10 also generally comprise a design texture 18 formed on the first surface 12 thereof. The edges 16 of the die 10 can also comprise a design or texturing thereon. When the die 10 is used to create or print on a three-dimensional object, for example, the texturing on the sides 16 can be replicated on a portion of the three-dimensional object.

The composite die 10 also presents a thickness 20 defined between the first and second surfaces 12, 14. The thickness 20 of the die 10 can be between 1/64 inch and ½ inch. In other applications, the thickness 20 of the die 10 can be less than 1/64 inch and greater than ½ inch. Preferably, for foil printing processes, the thickness 20 is about ⅛ inch. The thickness 20 of the die 10 can be selected based upon various factors, such as the depth of the design texture 18 to be etched into the die 10. Generally, thicker dies 10 can require more time for the heat to be transferred through the thickness of the die 10 and thinner dies 10 require less time for the heat to be transferred through the thickness of the die 10. While the thickness has been described as being between 1/64 inch and ½ inch, other die thicknesses less than 1/64 inch and above ½ inch can be used without departing from the scope and spirit of the present invention.

The composite dies 10 can be comprised of a combination of a polymer matrix having a filler comprised of metallic particles dispersed therein. The composite material can be comprised of any ratio of matrix to filler material. The ratio of matrix to filler material can be selected depending on many variables including desired material properties, such as thermal conductivity, hardness, magnetism, and flammability. The ratio of matrix to filler material can also be selected depending on desired cost of the die.

The die can comprise between about 10 wt. % and about 99 wt. % filler material Preferably, the die comprises between about 40 wt. % and about 80 wt. % filler material. Optimally, the composite material is comprises of between about 50 wt. % and about 70 wt. % filler material. Generally, as the wt. % of filler material increases, the thermal conductivity of the die also can increase. Other factors affecting the thermal conductivity also can include the shape of the filler material particles and the amount of porosity in the die. A person of ordinary skill in the art will recognize that additional ranges within the explicit ranges given above are contemplated and are within the present disclosure.

The polymer matrix can be any number of engineering materials that can withstand the elevated temperatures without zero or minimal degradation thereof. For example, the polymer matrix can be heated to temperatures up to and above 300° F. without any significant degradation of the polymer. Other polymer matrix materials can be heated to temperatures up to and above 250° F. without significant degradation of the polymer. The polymer matrix can also have some chemical resistance. The various polymer matrix materials also preferably comprise low flammability and sufficient laser etchability.

Optimal matrix material includes thermoplastics, thermosets, copolymers thereof, and blends thereof. For example, some matrix materials include acetal homopolymer, PBT (polybutylene terephthalate), polyethylenes such as PET (polyethylene terephthalate), acrylic, polypropylene, and polystyrene. An example of an acetal homopolymer is acetal resin under the trade name Delrin® by E.I. du Pont de Nemours and Company, DuPont Building, 1007 Market Street, Wilmington, Del. 19898. Other matrix materials can include PPS (polyphenylene sulfide), PETG (glycol-modified polyethylene terephthalate), cellulosics, polyester, ABS (acrylonitrile, butadiene, styrene), fluoropolymers, silicones, nylons, polyurethane.

In an embodiment, the metallic particles can be aluminum, copper, iron, nickel, stainless steel, and or carbon particles. The particles can be irregularly shaped and can be sized such that they comprise average particle dimensions between about 0.0005 and about 0.003 inches. Preferably, such particles comprise average particle dimensions between about 0.0005 and about 0.002 inches. The particles preferably can pass through a U.S. standard sieve mesh size 50. In some embodiments, the particles can pass through a U.S. standard sieve mesh size 60 or smaller. Optimally, such particles comprise average particle dimensions between about 0.0005 and about 0.001 inches. As used herein, average particle dimension means the average of the dimension in each of the three major axes. The smaller dimensioned particles enable the laser etching process to have a high resolution. As the particles get larger, the resolution can decrease. A person of ordinary skill in the art will recognize that additional ranges within the explicit ranges given above are contemplated and are within the present disclosure.

In other embodiments, alternative or additional elemental metal particles can be used in the metallic particle mixture. Such metallic particles include gold, silver, and other materials possessing high thermal conductivity or magnetism known to those of skill in the art. In addition, other metal can be selected, such as carbon, as igniters to enable clean matrix material burn off during laser etching. While the particles can be irregularly shaped, the metallic particulates can also be spherical in shape, flakes, and/or fibers dispersed within the polymeric matrix. A person of ordinary skill in the art will recognize that additional metallic particles can be used as filler materials. Such metallic particles can be selected for any number of desired properties, such as thermal conductivity, magnetism, hardness, and other material properties.

Referring to FIG. 2, in a first embodiment, the metallic particles 26 can be dispersed generally equally throughout the die 10. By having a homogeneous particle distribution, the resolution obtained during the laser etching process can be maximized and controlled. The die 10 according to the first embodiment generally comprises a single layer comprising a matrix material 22 and a filler material 24 substantially homogenously dispersed therein. The filler material 24 generally comprises a first metallic material 26. In other embodiments, the filler material 24 can comprise a mixture of two or more metallic materials substantially homogenously dispersed therein. In another embodiment, the die can comprise particles in a greater concentration proximate one surface.

In other embodiments, the die 10 can comprise a mixture of metallic particles in one region of the die and a single type of metallic particle in another region. For example, a die can comprise aluminum and iron particles in one region of the die for thermal conductivity and magnetism for connection to the heated plate. These particles can be relatively larger, in the range of less than about one-sixteenth of an inch, as the particles in the region will not likely undergo laser etching. In another region, the die 10 can comprise aluminum particles for thermal conductivity. The particles in this region can be relatively smaller, in the range of less than about 0.002 inches, as the particles in the region can undergo laser etching.

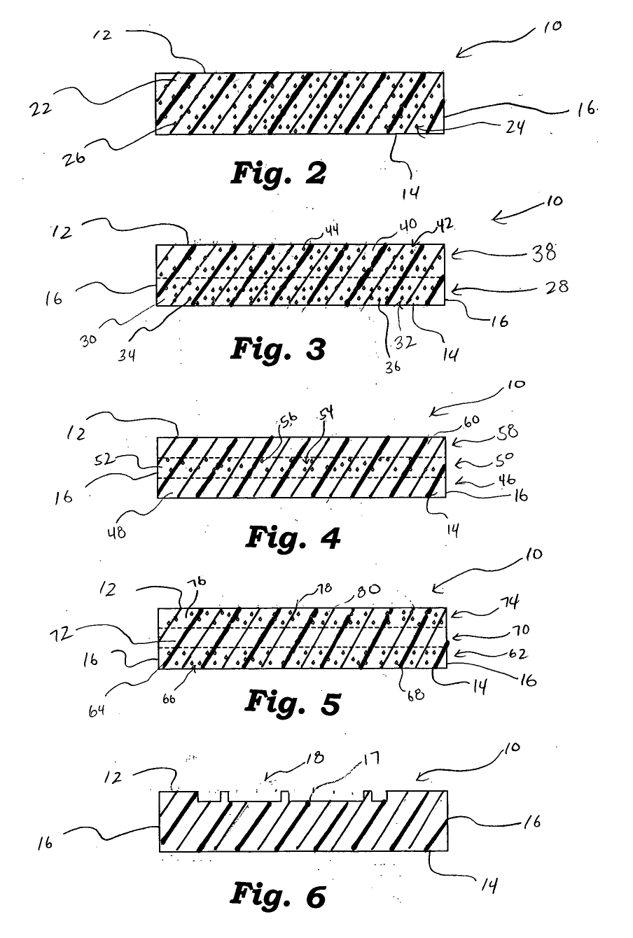

Referring to FIG. 3, the die 10 according to the second embodiment comprises a first layer 28 having a matrix 30 and a filler material 32. The filler material 32 comprises first metallic particles 34 and second metallic particles 36. The die 10 according to the second embodiment also comprises a second layer 38 comprising a matrix 40 and a filler material 42. The filler material 42 in the second layer 38, as depicted in FIG. 3, comprises a single metallic material 44. In another embodiment, the filler material 42 can be comprised of a mixture of two or more metallic materials.

Referring to FIG. 4, the metallic particles can be selectively more or less concentrated in specific portions of the die 10, such as layers. In the third embodiment, the particles are more concentrated near the center of the die 10. The die 10 according to the third embodiment comprises first, second, and third layers 46, 50, 58. The first layer 46 generally comprises a matrix material 48. The second layer 50 generally comprises a matrix material 52 and a filler material 54 comprised of a first metallic material 56. In another embodiment, the filler material 54 can be comprised of a mixture of two or more metallic materials. The third layer 58 comprises a matrix material 60.

Referring to FIG. 5, in a fourth embodiment, the particles can be more concentrated near the surfaces 12, 14 of the die 10. The die 10 according to the fourth embodiment generally comprises first, second, and third layers 62, 70, 74. The first layer 62 generally comprises a matrix material 64 and a filler material 66 comprised of a metallic material 68. The second layer 70 generally comprises a matrix material 72. The third layer 74 generally comprises a matrix material 76 and a filler material 78 comprised of a metallic material 80. In other embodiments, the filler material in the first and/or third layers 62, 74 can comprise a mixture of one or more metallic particles.

The die 10 can comprise some amount of porosity therein. Such porosity can be less than 20 volume percent of the die 10, as porosity can lead to decreased thermal conductivity. In other words, as the level of porosity decreases, the thermal conductivity of the die 10 will generally increase. Preferably, the porosity is less than 5 volume percent of the die 10. Optimally, there is substantially zero porosity in the die 10.

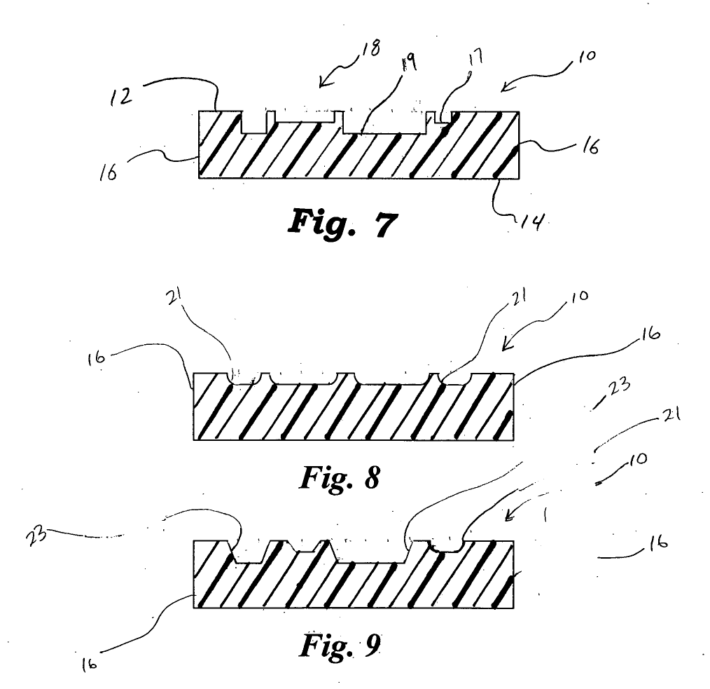

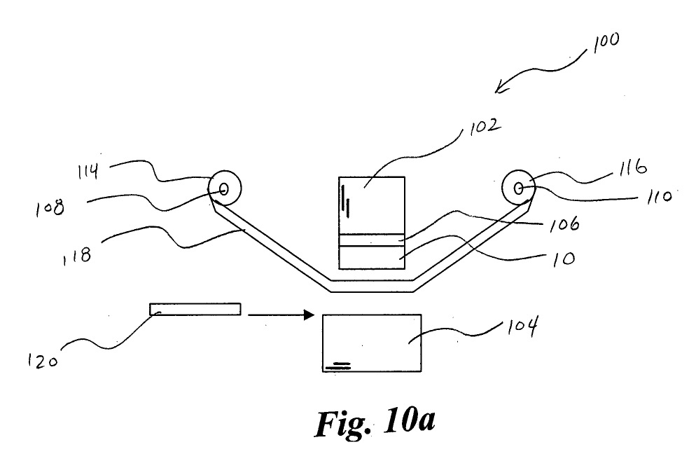

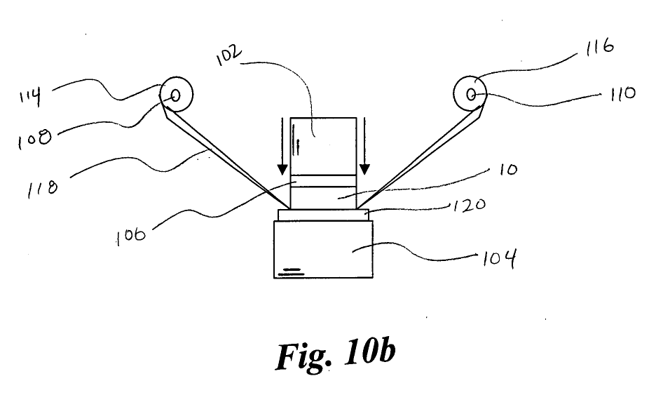

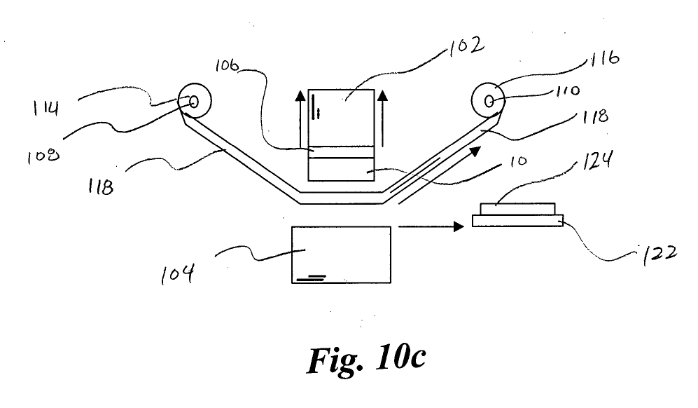

Referring to FIGS. 6-7, the design that can be etched into the die 10 can be a single-depth design (FIG. 6) or multiple-depth design (FIG. 7). For example, in FIG. 6, the design texture 18 can comprise a first depth 17. In FIG. 7, the design texture 18 can comprise a first depth 17 and a second depth 19. In other embodiments, the design texture 18 can have three or more depths. The depth of the laser etched design texture 18 can be up to and over one-eighth of an inch. The depth of the etch can be controlled using various settings such as speed of the laser, e.g., laser pulses per inch. In addition, the depth of etch can be controlled by controlling the laser power. Both single and multiple depth die designs can be performed during a single laser etching process step. The depth of the design can be any dimension greater than zero up to any dimension less than the total thickness 20 of the die. For example, for a die that is ⅛ inch, the depth of the design can be any dimension greater than zero up to ⅛ inch.

Referring to FIGS. 8 and 9, there can be a curved gradient 21 or a linear gradient 23 between the different depths of the design 18 and between the design 18 and the first surface 12 of the die 10. Referring to FIG. 8, the die 10 comprises a first depth 17 and curved gradients 21 between the first depth 17 and the first surface 12 of the die. In FIG. 8, the die 10 comprises a first depth 17 and a second depth 19. There is a curved gradient 21 between the first depth 17 and the first surface 12 of the die and linear gradients 23 between the first and second depths 17, 19 and the first surface 12 of the die. The different depths and the surface 12 of the die can also be stepped, as depicted generally in FIGS. 6 and 7. The design 18 can be also be a relief design, i.e., the design 18 can be etched such that is a relief image of the selected design. This type of design can be used, for example, in embossing images on paper or plastic.

The die 10 can comprise material properties to such that it has a maximum thermal conductivity to effectively transfer the heat between the heated block, through the die, through the foil, colored pigment, or other thermal transfer material, and into the media. Such heat transfer will enable a sufficient bond to be made between the thermal transfer material and the media. Metallic particles such as aluminum, copper, gold, iron, nickel, stainless steel, and silver can increase the thermal conductivity of the die.

To make the die 10, first the matrix and filler material are selected. Once the matrix and filler materials have been selected, the materials are mixed to form a composite material mixture. Generally, the matrix material can be mixed in pellet form with the filler material in powder form. Alternatively, the matrix material can be melted and then mixed with filler material to form the composite material mixture. If the matrix material is to be mixed in powder form, a wetting agent can be used to prevent the matrix material from becoming airborne. In addition, a wetting agent can be used in conjunction with the filler material powder to prevent the filler material from becoming airborne prior to extruding.

The composite material mixture is then placed in a hopper of extruder. When the composite matrix material contains pellet-form matrix material, the matrix material is melted during extrusion and effectively mixed with the powder filler material, conveyed in the extruder, and then extruded. When the matrix material contains melted matrix material, the melted matrix material is mixed with powder filler material during extrusion, the composite material is conveyed and extruded in extruder.

In other embodiments, such as the bi-layer or tri-layer embodiments depicted in FIGS. 3-5, two or three screws can be used to form each of the layers of the composite material. The layers are pinched, polymer welded, fused (e.g., with molded die portions), or otherwise joined together to form a die having a bi-layer or tri-layer structure.

In other embodiments, the die 10 is formed by other forming processes, such as by injection molding or other molding processes. In addition, dies comprised of thermosets can be mixed, placed in a shaped tray, and enabled to cure. Those of skill in the art will recognize that other forming processes can be used to form the die 10 without departing from the scope and spirit of the present invention.

The composite material is enabled to solidify and a die blank is cut from the solidified composite material into desired dimensions that can be used in a laser etch machine. The die blank is then placed into laser etch machine and the desired design or wording can be laser etched into die blank. In addition, locator or registration holes can be laser cut into individual dies and individual dies can then be laser cut from die blank.

In an embodiment, a carbon dioxide (CO₂) laser can be used to etch the selected design or wording onto the die blank. An example of a carbon dioxide (CO₂) laser platform is sold by Universal Laser Systems, Inc., of Scottsdale, Ariz. Stock material of the composite material can be inserted and placed on a work area of the carbon dioxide (CO₂) laser. Such a work area can comprise dimensions of, for example, 24″×12″. In a large system, the work area can comprise dimensions of, for example, 24′×12′. The stock material can comprise various dimensions up to the dimensions of the work are on the laser platform.

Other lasers that can be used to etch the texture or design into the die 10 can include Nd:YAG lasers, ruby lasers, and various diode lasers. Those of skill in the art will recognize that other lasers can be used to etch the texture or design into the die 10 without departing from the scope and spirit of the present invention.

A desired design to be etched into the die blank can be programmed into a computer and/or controller that are operably coupled to the laser system. The stock material can be positioned on the work area, which can include ruler guides to aid in positioning the material. Once the material is in place, a cover on the system can be closed and the laser can begin to etch the material. If the stock material is larger than the end die, the laser system can cut the desired end die out of the larger stock material. In addition, if positioning holes or tabs are desired, the laser system can cut the positioning holes or tabs out of the die material.

The laser can be powered between about 5 and about 250 Watts. Optimally, the laser is powered at 35 Watts and the laser etching is performed at 100% of 35 Watts. The laser can be run at between 1 and 1000 pluses per inch and above, and preferably at 1000 pulses per inch. In alternative units, the laser can be run at 50,000 pulses per second. The laser can be run between 0.01 and 200 inches per minute and above, and preferably at 10 inches per minute.

The hot foil printing process can be performed on a machine generally depicted as 100 in FIGS. 8a-8c. A hot foil process machine 100 generally comprises a heated block or hot plate 102 operably coupled to a pneumatic or fly-wheel mechanism that can operate the heated block 102 between a first, retracted position and a second, active or stamping position.

The hot foil process die 10 can be operably coupled to the heated block 102 using an adhesive 106 or magnetism, depending on the content of the composite materials included in the die 10. Such an adhesive 106 can include double-sided tape, although those skilled in the art will recognize that other materials can be used to adhesively couple the die to the heated block. In other embodiments, the die 10 can be mechanically coupled to the heated block 102 using mechanical fasteners or coupled to the block using a vacuum coupling.

The machine 100 also can comprise a first spindle 108 on which a first or fresh foil roll 114 can be positioned and a second spindle 110 on which a second or spent foil roll 116 can be positioned. Fresh foil 112 including a first end of a foil substrate 118 can be placed on the first spindle 108 and a second end of the foil substrate 118 can be placed on the second spindle 110. As the foil 112 is used, the foil substrate 118 will be transferred from the first spindle 108 to the second spindle 110. Those of ordinary skill in the art will recognize that other substrates can be used to carry the foil, such as single continuous or separated sheets, without departing from the scope and spirit of the present invention.

One or more substrates or virgin media 120 without foil are placed and/or stacked in a first bin or location. The fresh foil roll 116 having fresh foil 112 is placed on a first spindle 108. The one or more substrates 120 without foil are transferred to a printing block or platen 104 located below a heated bock 102 having a process die 10 mounted theron. Foil 112 is transferred from a position on the fresh foil roll 114 to a position intermediate the printing and heated blocks 104, 102. The heated block 102 and a process die 10 having a selected design texture 18 thereon are operated between a retracted position to a printing position to effect the foil 112 against the substrates 120 without foil on the printing block 104 such that foil copy 124 of the selected design texture 18 is transferred to the substrate 120 to create a printed media or substrate 122. The printed media 122 of the selected design are transferred to a second bin or location. Spent foil 112 is transferred to a spent foil roll 116 placed on a second spindle 110.

When using gold foil, for example, the block 102 can be heated to an elevated temperature, for example, in the range of 150 to 400° F. The temperature of the block 102 and die 10 can vary with the type of glue that is used to couple the foil 112 to the foil substrate 118 upon which the foil 112 is carried. The temperature of the block 102 can also vary with the thickness of the foil 112 being printed, the type of media 120 being printed upon, and other environmental conditions.

The pressure used during printing can be in the range of 1 to 10,000 psi, depending upon the type of substrate 120 being used. The pressure used during printing can also vary with the type and thickness of the foil 112 being printed, the type of media 120 being printed upon, and other environmental conditions. In embodiments in which the foil 112 is being embossed onto a substrate 120, the pressures can be higher.

The time used during printing can be in the range of 1/100 of a second to 1 second. Like the temperature and pressure, the time used during printing can vary with the type and thickness of the foil 112 being printed, the type of media 120 being printed upon, and other environmental conditions.

Although the present invention has been described with reference to particular embodiments, one skilled in the art will recognize that changes may be made in form and detail without departing from the spirit and the scope of the invention. For example, the die according to the present invention can be used as a printing die for ink printing or printing with other printing materials. Therefore, the illustrated embodiments should be considered in all respects as illustrative and not restrictive.

1. A composite printing die comprising:
a body and a texture selectively defined thereon to form a printing surface, the body comprising a polymeric matrix and a filler dispersed in the polymeric matrix, wherein the filler comprises particles comprising an elemental metal, any alloys thereof, and any combinations thereof.

2. The die of claim 1, wherein the polymeric matrix is selected from the group consisting of: thermoplastic polymers, copolymers thereof, and blends thereof.

3. The die of claim 1, wherein the polymeric matrix is selected from the group consisting of: thermoset polymers, copolymers thereof, and blends thereof.

4. The die of claim 1, wherein the polymeric matrix is selected from the group consisting of: acetal, PBT (polybutylene terephthalate), PET (polyethylene terephthalate), and acrylic.

5. The die of claim 1, wherein the particles comprising an elemental metal are selected from the group consisting of copper, aluminum, iron, any alloys thereof, and any combinations thereof.

6. The die of claim 1, wherein the die comprises between about 40 wt. % and about 80 wt. % of the filler.

7. The die of claim 1, wherein the die comprises between about 20 wt. % and about 60 wt. % of the polymeric matrix.

8. The die of claim 1, wherein the filler comprises a first collection of particles comprising elemental iron and any alloys thereof and a second collection of particles comprising an elemental metal are selected from the group consisting of copper, aluminum, any alloys thereof, and any combinations thereof.

9. The die of claim 8, wherein the die comprises between about 40 and about 60 wt. % of the first collection of particles and the die comprises between about 40 and about 60 wt. % of the second collection of particles.

10. The die of claim 8, wherein the die comprises between about 45 and about 55 wt. % of the first collection of particles and the die comprises between about 45 and about 55 wt. % of the second collection of particles.

11. The die of claim 1, wherein the particles comprising the elemental metal comprise average particle dimensions between about 0.0005 inches and about 0.002 inches.

12. The die of claim 1, wherein the particles comprising the elemental metal comprise average particle dimensions between about 0.0005 inches and about 0.001 inches.

13. The die of claim 1, wherein the particles comprising the elemental metal pass through a U.S. standard sieve mesh size 50.

14. The die of claim 1, wherein the particles comprising the elemental metal pass through a U.S. standard sieve mesh size 60.

15. The die of claim 1, wherein the filler is substantially homogeneously dispersed in the polymeric matrix.

16. The die of claim 1, wherein the body comprises a first major surface and a second major surface, the texture being selectively defined on the first major surface, wherein a concentration of the particles comprising the elemental metal is greater proximate the first surface than proximate the second surface.

17. A process of making a printing die comprising providing a body formed of a polymer matrix and laser etching a texture into the body to form a printing surface thereon.

18. The process of claim 17, wherein the laser etching comprises forming a first depth and a second depth on a first surface of the body.

19. The process of claim 17, further comprising providing a filler dispersed in the polymeric matrix, wherein the filler comprises particles comprising an elemental metal, any alloys thereof, and any combinations thereof.

20. The process of claim 19, further comprising selecting the elemental metal from the group consisting of copper, aluminum, iron, any alloys thereof, and any combinations thereof.

21. The process of claim 17, wherein the polymeric matrix is selected from the group consisting of: thermosets, thermoplastics, copolymers thereof, and blends thereof.

22. The process of claim 17, further comprising selecting the polymeric matrix from the group consisting of: acetal, PBT (polybutylene terephthalate), PET (polyethylene terephthalate), and acrylic.

23. The process of claim 17, wherein the etching is performed using a carbon dioxide laser.

24. A method of using a printing die comprising:
providing a die comprising a body and a texture defined therein, wherein the body comprises a polymeric matrix and a filler dispersed in the polymeric matrix, the filler comprises particles comprising an elemental metal; and
effecting movement of the die relative to a print material positioned intermediate the die and a substrate to form a replication of the texture on the substrate.

25. The method of claim 24, wherein forming the replication comprises transferring at least a portion of the print material on the substrate.

26. The method of claim 25, further comprising selecting the print material from the group consisting of foil, colored pigment, and any combinations thereof.

27. The method of claim 24, wherein forming the replication comprises embossing the substrate.

28. The method of claim 27, further comprising selecting the substrate from the group consisting of: fibrous material, polymer, and any combinations thereof.

29. A printing die comprising:
a body comprising a polymeric matrix and a filler dispersed in the polymeric matrix, wherein the filler comprises particles comprising an elemental metal, any alloys thereof, and any combinations thereof, the body further comprising a first major surface and a generally opposed printing surface, the printing surface having a texture selectively defined thereon, the texture comprising a first texture surface and a first gradient surface defined between the first texture surface and the printing surface.

30. The printing die of claim 29, wherein the first gradient surface is generally linear.

31. The printing die of claim 29, wherein the first gradient surface is generally curvilinear.

32. The printing die of claim 29, wherein the texture is defined outwardly of the printing surface such that the printing surface is generally intermediate the first major surface and the first texture surface.

33. The printing die of claim 29, wherein the texture is defined inwardly of the printing surface such that the first texture surface is generally intermediate the first major surface and the printing surface.

34. The printing die of claim 29 further comprising a second texture surface and a second gradient surface defined between the second texture surface and the printing surface.

35. A method of printing comprising:
providing a die comprising a body comprising a polymeric matrix and a filler dispersed in the polymeric matrix, wherein the filler comprises particles comprising an elemental metal, any alloys thereof, and any combinations thereof, the body further comprising a first major surface and a generally opposed printing surface, the printing surface having a texture selectively defined thereon, the texture comprising a first texture surface and a gradient surface defined between the first texture surface and the printing surface,
effecting movement of the die relative to a print material selectively positioned intermediate the die and a substrate to form a replication of the texture on the substrate, wherein forming the replication comprises transferring at least a portion of the print material on the substrate.

36. The printing die of claim 35, wherein the gradient surface is formed to be generally linear.

37. The printing die of claim 35, wherein the gradient surface is formed to be generally curvilinear.

38. The method of claim 35, further comprising elevating a temperature of the die prior to effecting movement of the die.

39. The method of claim 35, further comprising selecting the print material from the group consisting of foil, colored pigment, and any combinations thereof.
